(19) United States
(12) Patent Application Publication
(10) Pub. No.: US 2026/0074644 A1
(43) Pub. Date: Mar. 12, 2026

(54) ASSEMBLY FOR SECURING SOLAR PANEL MODULES TO SURFACE

(71) Applicant: Unirac, Inc., Albuquerque, NM (US)

(72) Inventor: Michael Serron, Arvada, CO (US)

(21) Appl. No.: 18/826,988

(22) Filed: Sep. 6, 2024

(51) Int. Cl. H02S 20/23; F16B 43/00; F16J 15/14

(52) U.S. Cl. CPC H02S 20/23; F16B 43/001; F16J 15/14

(57) ABSTRACT

An assembly includes a base and a seal. The bas has a top, a bottom, a first port disposed on the top, a second port disposed on the top, and an aperture disposed on the top. The aperture is configured to receive a portion of a fastener disposed in a surface. The base also has a cavity disposed on the bottom and a channel circumscribing the cavity. The cavity is configured to receive a sealant injected into the first port for sealing the assembly against the surface. A seal is disposed in the channel.

### BACKGROUND

The solar industry is growing worldwide and, as a result, more efficient structures are desirable for mounting photovoltaic modules or solar panel modules to a structure, such as a roof of a home or other building. While different structures are known, there is a desire to reduce their complexity during the installation of the solar panel modules. Therefore, there is a need for improved equipment to mount solar panel modules.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an exploded view of an example assembly that may be used to secure an attachment mechanism to a surface for supporting solar panel modules, according to examples of the present disclosure.

FIG. 2 illustrates a top view of an example base of the assembly of FIG. 1, according to examples of the present disclosure.

FIG. 3 illustrates a bottom planar view of the base of FIG. 2, with a seal attached to the base, according to examples of the present disclosure.

FIG. 4 illustrates a side view of the base of FIG. 2, according to examples of the present disclosure.

FIG. 5 illustrates a cross-sectional view of the base and the seal of FIG. 3, taken along line A-A of FIG. 2, according to examples of the present disclosure.

FIG. 6 illustrates a bottom isometric view of the base of FIG. 2, according to examples of the present disclosure.

FIG. 7 illustrates a bottom planar view of the base of FIG. 2, according to examples of the present disclosure.

FIG. 8 illustrates a top isometric view of the seal of FIG. 3, according to examples of the present disclosure.

FIG. 9 illustrates a bottom isometric view of the seal of FIG. 3, according to examples of the present disclosure.

FIG. 10 illustrates a bottom planar view of the seal of FIG. 3, according to examples of the present disclosure.

FIG. 11 illustrates a cross-sectional view of the seal of FIG. 3, taken along line B-B of FIG. 8, according to examples of the present disclosure.

FIG. 12 illustrates an example first attachment mechanism secured to a surface using the assembly of FIG. 1, according to examples of the present disclosure.

FIG. 13 illustrates an example second attachment mechanism secured to a surface using the assembly of FIG. 1, according to examples of the present disclosure.

FIG. 14 illustrates the second attachment mechanism of FIG. 13 secured to the surface, according to examples of the present disclosure.

### DETAILED DESCRIPTION

This application is directed, at least in part, to an assembly that seals against a surface to prevent an ingress of liquid into the surface, according to examples of the present disclosure. In an embodiment, the assembly may include a base, a seal, and a fastener. The base may have a cavity and a channel disposed around the cavity. The seal may be disposed within the channel. The fastener, which is used to secure the assembly to the surface, may be disposed in the surface and through the base at a location within the cavity. A sealant may be injected into the cavity, around the fastener, for sealing the base against the surface. In an embodiment, one or more attachment mechanisms, such as brackets, mounts, standoffs, etc., may attach to the assembly for mounting solar panel modules or components thereof, such as brackets, mounts, etc., to the surface. Although referred to herein as an “assembly,” the assembly may be representative of an apparatus, attachment, anchor, device, etc., configured to secure solar panel modules to the surface.

In an embodiment, the base may include a bottom configured to be disposed against the surface, and a top opposite the bottom. The cavity (e.g., chamber, void, cutout, etc.) may be formed in the bottom of the base. In an embodiment, the cavity includes a central area (e.g., portion, section, etc.) that is circular in shape and two arms that extend from diametrically opposed positions on either side of the central area. For example, a first arm may extend from the central area and a second arm may extend from the central area, at a location opposed from the first arm. However, the central area, the first arm, and the second arm may be fluidly connected together to permit the sealant to flow throughout the cavity.

The base may include an aperture to accommodate the fastener. In an embodiment, the aperture may extend through the base, from the top to the bottom, at a location within (e.g., internal to) the central area of the cavity. The base also includes a first port and a second port. The first port may represent an inlet in which the sealant is injected into the cavity. The second port may represent an outlet whereby air within the cavity is vented as the sealant is injected into the cavity. The first port may extend through the base, from the top to the bottom, at a location within the first arm. The second port may extend through the base, from the top to the bottom, at a location within the second arm.

In an embodiment, the first port may be disposed at an acute angle relative to the top, the second port may be disposed perpendicular to the top, and/or the aperture may be disposed perpendicularly to the top. The acuate nature of the first port may assist in routing the sealant into and throughout the cavity. However, the first port may be oriented at other angles. Additionally, the first port may be conically shaped to accommodate a nozzle used to inject the sealant into the cavity. Other shapes of the first port, however, are envisioned (e.g., elliptical, etc.). In an embodiment, the sealant may be injected or adhered into the cavity before or after the base is secured to the surface. Examples of the sealant may include butyl, silicone, rubber, EPDM, mechanical, foam, etc. In an embodiment, the sealant may be a flowable sealant or a non-flowable sealant (e.g., butyl).

The channel may be disposed around the cavity and may receive the seal. In an embodiment, the channel may be disposed around an entirety of the cavity or less an entirety of the cavity (e.g., on certain sides). Regardless, the seal may be shaped and sized to reside within the channel formed in the base. The channel may include any suitable shape. For example, the channel may serpentine, circumnavigate, circumscribe, etc., around the central area, the first arm, and the second arm of the cavity. In an embodiment, the seal may include one or more fingers (e.g., flanges, limbs, appendages, etc.) that seal against the surface. For example, as the fastener is tightened, so as to secure the base against the surface, the fingers may be urged against the surface.

To install the assembly, initially, a hole is drilled into the surface to accommodate the fastener. The fastener, which may represent an expanding concrete anchor, may be at least partially disposed into the hole. A post (e.g., stud) of the fastener may extend external to the surface (e.g., above the surface). The fastener may include a first end disposed within the surface, or within the hole of the surface, and a second end disposed external to the surface. The aperture in the base may be disposed over a post. A nut may be threaded onto the post, adjacent to the top of the base, and tightened to secure the base against the surface. During tightening of the nut, as indicated above, the fingers of the seal may become compressed against the surface. In an embodiment, once secured, the sealant may be injected into the cavity, via the first port, to seal around the hole. As the sealant is injected the sealant may flow around the fastener towards the second port. As the sealant fills the cavity, air is purged out of the cavity via the second port. The seal restrains the sealant within the cavity and prevents the sealant exiting out sides of the base, for example. The sealant may exit the cavity, via the second port, to provide a visual indication that the cavity is filled with the sealant. At this time, an installer may refrain from injecting additional sealant into the cavity.

Although the discussion is with regard to injecting the sealant after the nut is tightened, in an embodiment, the sealant may be injected before the nut is fastened. Moreover, the sealant may be a non-flowable sealant (e.g., butyl) that is applied to the base.

Although described as including the first port and the second port, in an embodiment, the first port and the second port may be omitted from the base. In such instances, the base may include the aperture through which the fastener is disposed. However, sealant may not be injected into the cavity via the first port. Instead, a sealant may be pre-applied within the cavity (e.g., before the base is disposed against the surface) and the base may be sealed against the surface via tightening of the nut. In an embodiment, the sealant may be pre-applied to the base via injecting the sealant into the cavity (e.g., from the bottom of the base) and/or applying the sealant as strips, etc., such as butyl. In an embodiment, the sealant may be flowable or non-flowable.

Still, in an embodiment, the sealant may be omitted and the seal may prevent an ingress of liquid into the surface. In such instances, the base may include the cavity, but the sealant may not be injected, adhered, within, etc. the cavity. The seal, which may be a butyl seal, may seal around the cavity to prevent an ingress of liquid into the surface.

In an embodiment, the attachment mechanism may be disposed over the post of the fastener. For example, the attachment mechanism may include a hole, opening, aperture, passage, etc., that is disposed over, onto, etc., the post. In an embodiment, the attachment mechanism may be secured to the post via a second nut, or via the nut that secures the base against the surface. For example, the attachment mechanism may be disposed between the nut and the second nut, and secured to the post via tightening of the second nut. In the latter example, the attachment mechanism may be disposed between the base and the nut, and secured during tightening of the nut. The attachment mechanism may support components of the solar panel module, such as frames, rails, brackets, etc., thereof.

The surface may represent any suitable surface, such as a concrete roof. However, although discussed herein with regard to a concrete roof, the surface may represent other suitable surfaces, such as a composite shingle roof, a metal roof, ceramic tile roof, etc. In such instances, the fastener may represent a bolt, screw, etc., and the sealant may similarly seal around the fastener for preventing an ingress of liquid into the surface.

The base may be manufactured from metal, plastics, components, etc. In an embodiment, the base may be manufactured via cast, stamping, injection molding, and/or milling techniques. The seal may be manufactured from rubbers, such as ethylene propylene diene monomer (EPDM).

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

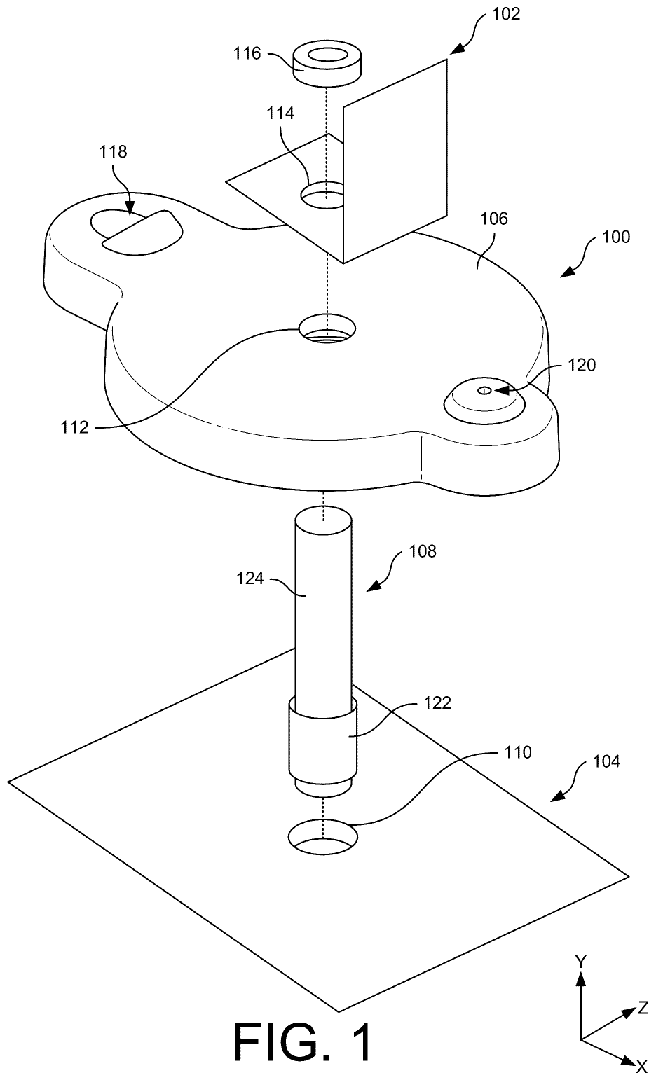

FIG. 1 illustrates an example assembly 100 that may be used to secure an attachment mechanism 102 to a surface 104, according to examples of the present disclosure. In an embodiment, the assembly 100 may include a base 106 and a fastener 108. The fastener 108 may be at least partially disposed into a hole 110 in the surface 104 and extend through an aperture 112 in the base 106. The attachment mechanism 102 may include an opening 114 that is disposed over the fastener 108. A nut 116, for example, may be threaded onto a post 124 of the fastener 108. As the nut 116 is driven onto the fastener 108, the attachment mechanism 102 may be become secured to the surface 104.

The base 106 may include a first port 118 and a second port 120 that are fluidly connected to a cavity of the base 106. As will be explained herein, a sealant may be injected into the first port 118 to fill the cavity. Air within the cavity may vent out the second port 120 as the sealant is injected. Additionally, a seal may be disposed between the base 106 and the surface 104. When the nut 116 is fastened the seal may become compressed against the surface 104. The seal may also contain the sealant within the cavity to avoid the sealant permeating out sides of the base 106 and/or beyond a perimeter of the seal.

The surface 104 may represent any suitable surface. In an embodiment, the surface 104 may be concrete, mason, etc. In an embodiment, the fastener 108 may be a concrete anchor that includes sleeve 122 configured to expand in the hole 110 for securing the fastener 108 within the hole 110 or to the surface 104.

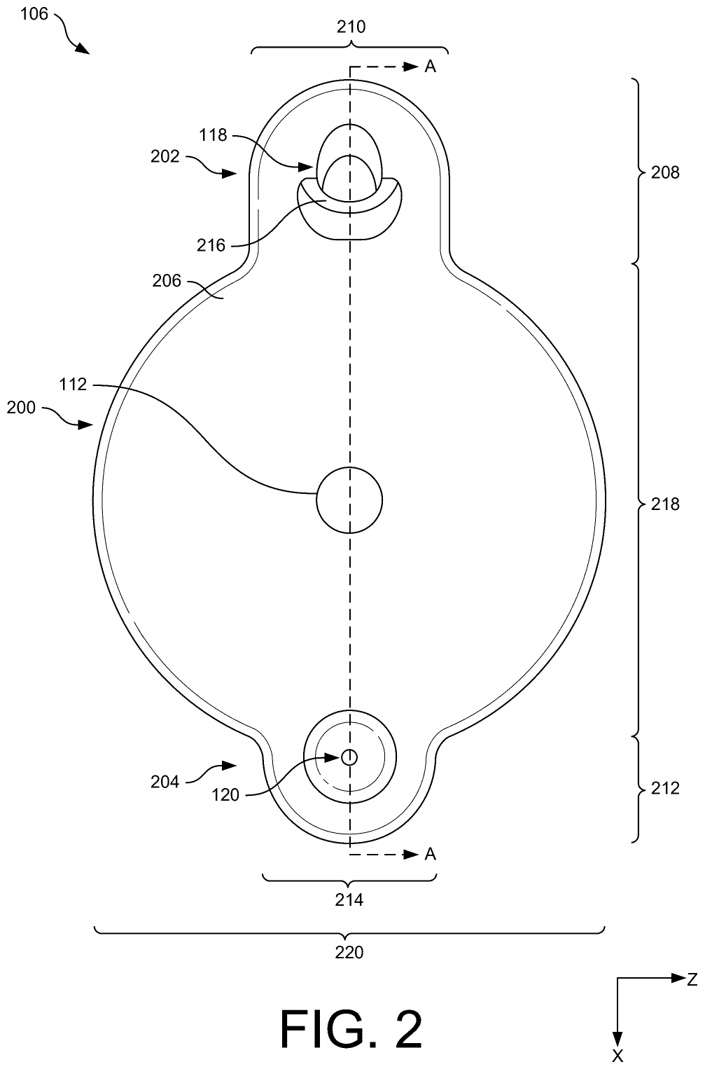

FIG. 2 illustrates a top view of the base 106, according to examples of the present disclosure. The base 106 may include a central region 200, a first arm 202, and a second arm 204. The central region 200 may represent a section, area, etc., of the base 106. The first arm 202 and the second arm 204 may represent flanges, protrusion, etc., that extend from opposing sides of the central region 200. In an embodiment, the first arm 202 and the second arm 204 may extend from diametrically opposed locations on the central region 200. However, although described as separate components, the central region 200, the first arm 202, and the second arm 204 may be integrally formed from a single piece of material (e.g., metal).

The base 106 may include a top 206 configured to be spaced apart from the surface 104 when installed (e.g., in the Y-direction). The aperture 112, the first port 118, and the second port 120 may be disposed through, or defined by, the top 206. In an embodiment, the aperture 112, the first port 118, and/or the second port 120 may be aligned (e.g., along a X-Y plane). The aperture 112 may be disposed through the central region 200 of the base 106, the first port 118 may be disposed through the first arm 202 of the base 106, and/or the second port 120 may be disposed through the second arm 204 of the base 106.

The first arm 202 may include a first length 208 (e.g., in the X-direction) and a first width 210 (e.g., in the Z-direction). The second arm 204 may include a second length 212 (e.g., in the X-direction) and a second width 214 (e.g., in the Z-direction). In an embodiment, the first length 208 may be greater than the second length 212, and/or the first width 210 may be greater than the second width 214. The first length 208 and the first width 210 may accommodate the first port 118, which is sized to receive a nipple, nozzle, etc., of a container for injecting the sealant into the cavity. Additionally, a flange 216 may be disposed at least partially around (e.g., at least on one side) the first port 118. In an embodiment, the flange 216 may be disposed above the top 206 of the base 106. The flange 216 may assist in directing the nozzle of the container into the first port 118.

The central region 200 may include a third length 218 (e.g., in the X-direction) that is greater than the first length 208 and/or the second length 212. The central region 200 may include a third width 220 (e.g., in the Z-direction) that extends between opposing sides of the base 106. The third width 220 may be greater than the first width 210 and/or the second width 214.

Although the aperture 112, the first port 118, and the second port 120 are shown at certain locations on the base 106, and/or having a certain size, shape, etc., other variations are envisioned. For example, the base 106 may accommodate more than one fastener 108 that is secured into the surface 104. In such instances, the base 106 may include more than one of the apertures 112. As another example, the central region 200 may be square shaped, hexagonally shaped, elliptically shaped, etc., instead of being circularly shaped. The base 106 may also be shaped differently than described and shown. Moreover, although the base 106 is described as including two of the arms (i.e., the first arm 202 and the second arm 204), the base 106 may include more than or less than two of the arms, and/or the arms may extend from the central region 200 differently than shown.

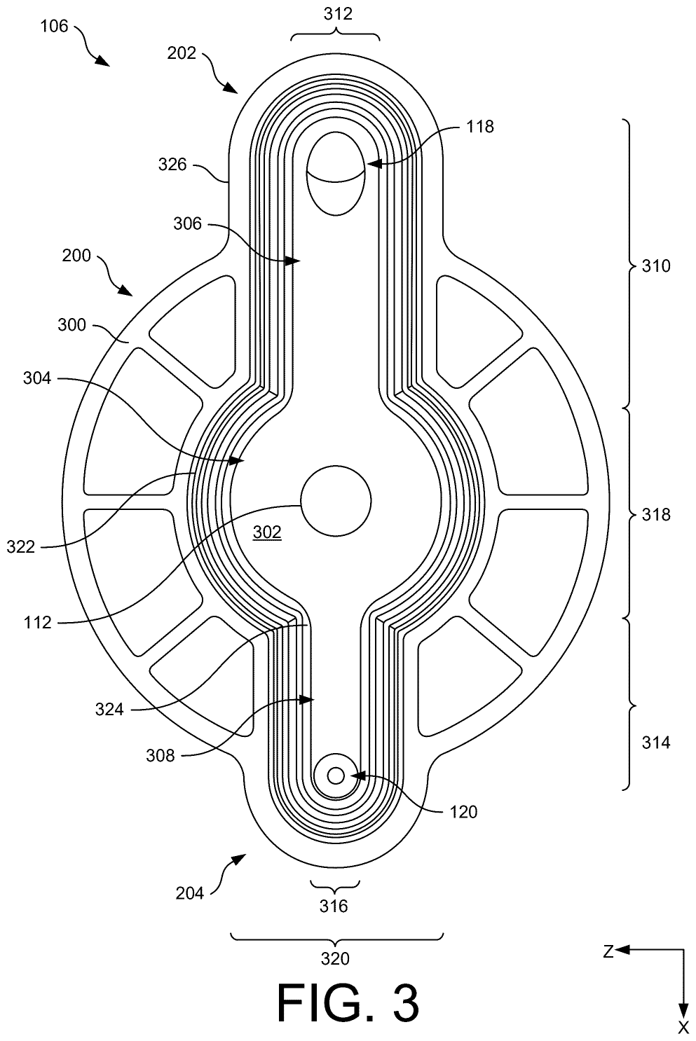

FIG. 3 illustrates a bottom view of the base 106, according to examples of the present disclosure. As introduced above, the base 106 may include the central region 200, the first arm 202, and the second arm 204. The base 106 may include a bottom 300 that defines a cavity 302. The aperture 112, the first port 118, and the second port 120 may be fluidly connected to the cavity 302. In doing so, the fastener 108 may extend through the aperture 112, the sealant may be injected into the cavity 302 via the first port 118, and air may vent out the cavity 302 via the second port 120 as the sealant is injected. In an embodiment, the sealant may include butyl, silicone, rubber, EPDM, mechanical, foam, etc. In an embodiment, the sealant may be a flowable sealant or a non-flowable sealant (e.g., butyl).

In an embodiment, the cavity 302 may be similarly shaped as the base 106. For example, the cavity 302 may include a central region 304, a first arm 306, and a second arm 308. The central region 304 may be disposed below (e.g. in the Y-direction) the central region 200 of the base 106. The first arm 306 may be disposed at least partially below (e.g. in the Y-direction) the central region 200 and/or the first arm 202, and/or the second arm 308 may be disposed at least partially below (e.g. in the Y-direction) the central region 200 and/or the second arm 204. The cavity 302 is shown being shaped similar to the base 106, however, in an embodiment, the cavity 302 may be shaped differently than the base 106.

The first arm 306 may include a first length 310 (e.g., in the X-direction) and/or a first width 312 (e.g., in the Z-direction). The second arm 204 may include a second length 314 (e.g., in the X-direction) and/or a second width 316 (e.g., in the Z-direction). In an embodiment, the first length 310 may be greater than the second length 314, and/or the first width 312 may be greater than the second width 316. The central region 304 may include a third length 318 (e.g., in the X-direction) that is less than the first length 310 and/or greater than the second length 314. The central region 304 may include a third width 320 (e.g., in the Z-direction) that is greater than the first width 312 and/or the second width 316.

A seal 322 is disposed around the cavity 302. In an embodiment, the seal 322 may be disposed around an entirety of the cavity 302, or less than an entirety of the cavity 302. The seal 322 may be disposed within a channel formed in the bottom 300 of the base 106. As shown, the seal 322 may circumnavigate, extend, or be disposed around the cavity 302. A sidewall 324 may separate the cavity 302 from the channel in which the seal 322 is disposed. When installed, the seal 322 may be disposed against the surface 104 and compress against the surface 104 via tightening of the nut 116, for example. The seal 322 may enclose the cavity 302, for example, to contain the sealant within the cavity 302. In addition, the seal 322 may enclose the cavity 302 to assist in routing the sealant throughout the cavity 302. The base 106 may also include a perimeter 326 and the seal 322 may be disposed internal to the perimeter 326.

The seal 322 may be manufactured from a plurality of materials, such as butyl, silicone, rubber, EPDM, foam, etc. In an embodiment, the seal 322 may be rigid, deformable, etc.

In an embodiment, the first port 118 and the second port 120 may be omitted from the base 106. Instead, the base 106 may be sealed against the surface 104 via pre-applying the sealant to the base 106. The base 106 may include the aperture 112 through which the post 124 of the fastener 108 is disposed. However, the sealant (e.g., butyl) may be pre-applied within the cavity 302 (e.g., before the base 106 is disposed against the surface 104) and the base 106 may be sealed against the surface 104 via tightening of the nut 116. In an embodiment, the sealant may be pre-applied to the base 106 via injecting the sealant into the cavity 302 (e.g., from the bottom 300) and/or applying butyl within the cavity 302.

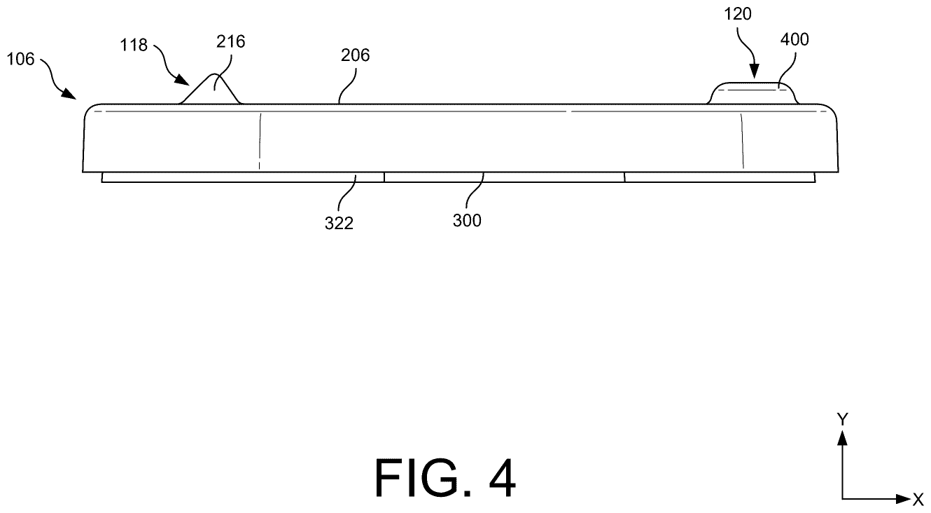

FIG. 4 illustrates a side view of the base 106, according to examples of the present disclosure. The flange 216 may extend above the top 206. The base 106 may also include a protrusion 400 disposed above the top 206, through which the second port 120 is disposed. The seal 322 may be attached to the base 106. In an embodiment, the seal 322 may extend below (e.g., in the Y-direction) the bottom 300. However, when the base 106 is secured to the surface 104, the seal 322 may at least partially compress (e.g., flatten in the Y-direction) to seal against the surface 104.

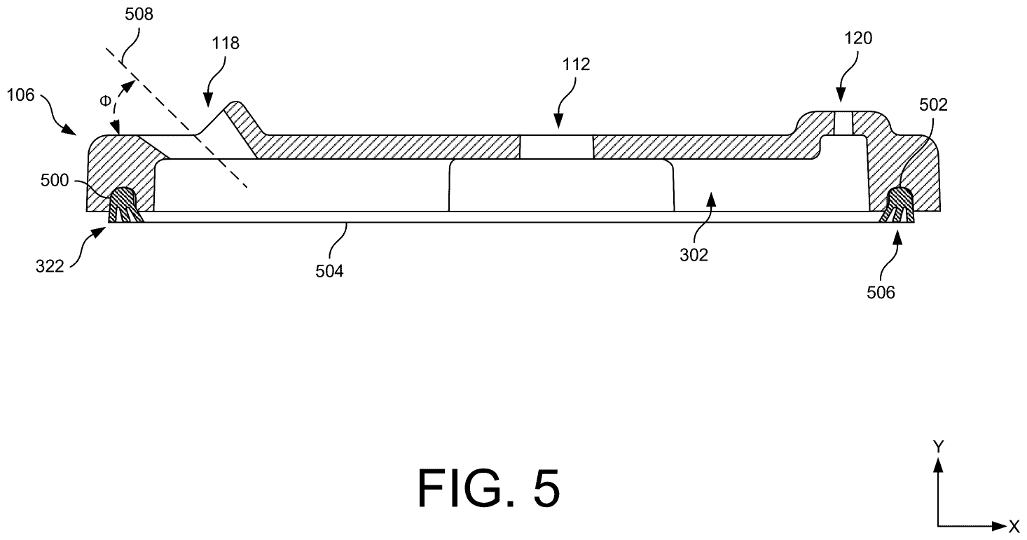

FIG. 5 illustrates a cross-sectional view of the base 106 and the seal 322, taken along line A-A of FIG. 2, according to examples of the present disclosure. As introduced above, the base 106 may define a channel 500 in which the seal 322 is at least partially disposed. For example, the seal 322 may include a top 502 and a bottom 504, where the top 502 may be disposed within and/or abut an interior surface of the channel 500 formed in the bottom 300. The bottom 504 may be disposed external to the channel 500 and contact the surface 104. The seal 322 may include one or more fingers 506 that abut the surface 104. In an embodiment, the seal 322 may be formed via flowable or non-flowable sealants being applied or disposed within the channel 500.

The aperture 112, the first port 118, and the second port 120 are shown extending through the base 106, between the top 206 and the bottom 300. The aperture 112, the first port 118, and the second port 120 are also shown being fluidly connected to the cavity 302. In an embodiment, the aperture 112 and the second port 120 may be arranged perpendicular relative to the top 206 (or the bottom 300) of the base 106. The first port 118 may be arranged at an acute angle relative to the top 206. For example, the first port 118 may include an axis 508 that is disposed at an acute angle φ relative to the top 206 (or a X-Z plane disposed along the top 206). However, although described as being oriented at an acute angle, the first port 118 may be oriented perpendicularly to the top 206. The first port 118 may also be elliptically shaped along the axis 508. Other shapes, however, are envisioned.

The aperture 112 may accommodate a cross-sectional dimension of the fastener 108, such as the post 124 of the fastener 108 that is configured to extend above the top 206 of the base 106. In an embodiment, the aperture 112 may be located closer to the second port 120 as compared to the first port 118. In an embodiment, the cavity 302 may include a consistent depth (e.g., in the Y-direction) and/or a variable depth.

In an embodiment, the first port 118 may be sized larger than the second port 120. For example, the first port 118 may include a first cross-sectional dimension (e.g., in the Z-direction) and the second port 120 may include a second cross-sectional dimension (e.g., in the Z-direction) that is less than the first cross-sectional dimension. Additionally, the first port 118 may be conically shaped and/or the second port 120 may be circularly shaped. The first port 118, the second port 120, and/or the aperture 112 may be shaped and/or oriented differently than shown and described. For example, the first port may be elliptically shaped and/or oriented perpendicular to the top 206.

In an embodiment, the first length 310 and the first width 312 may accommodate the first cross-sectional dimension of the first port 118 and/or assist in routing the sealant through the cavity 302. For example, during injection, the sealant may flow from a location within the cavity 302 proximate to the first port 118, to the central region 304, into the second arm 308 and out the second port 120. As shown, the first port 118 and the second port 120 may be located at ends of the first arm 306 and the second arm 308, respectively, spaced apart from the central region 304.

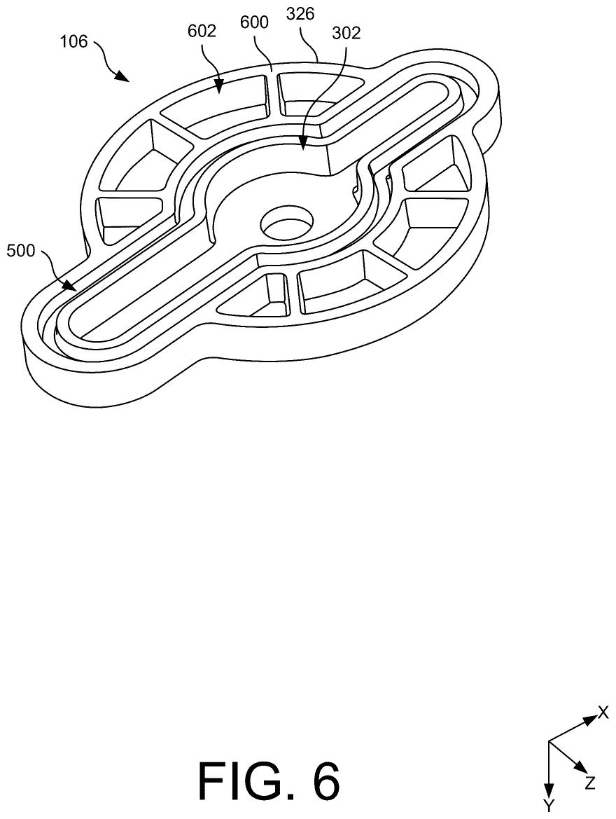

FIG. 6 illustrates a bottom isometric view of the base 106, showing the seal 322 removed, according to examples of the present disclosure. The base 106 may include the channel 500, which extends around, circumnavigates, external to, etc., the cavity 302. In an embodiment, the cavity 302 may be formed within a bottom surface 600 of the base 106 The base 106 may include one or more pockets 602 for reducing a weight and material of the base 106. The pocket 602 may be disposed between the channel 500 and the perimeter 326 of the base 106.

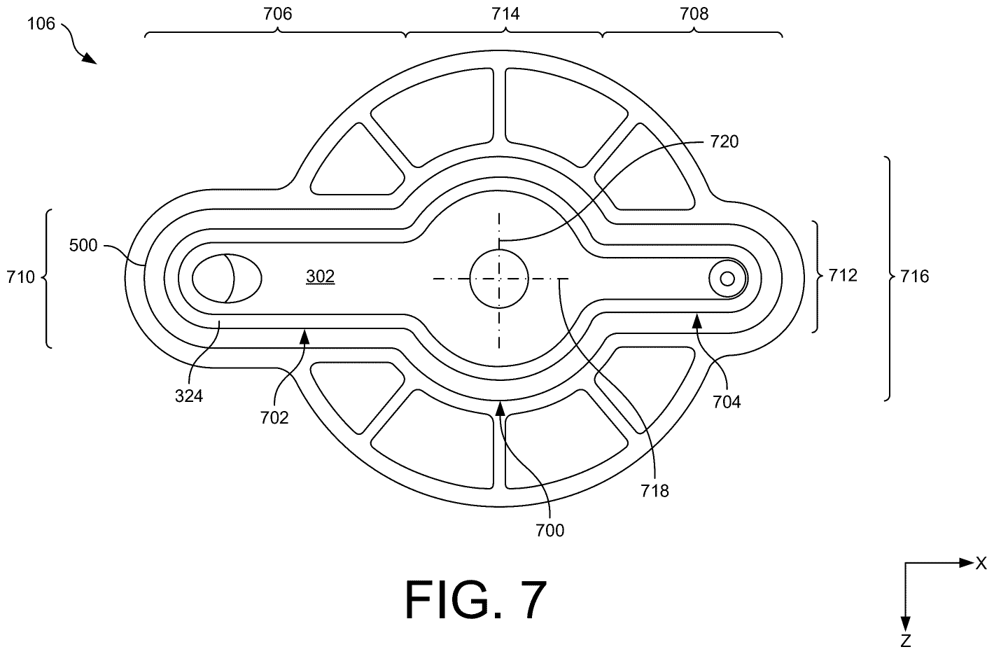

FIG. 7 illustrates a bottom view of the base 106, showing the seal 322 removed to illustrate details of the channel 500, according to examples of the present disclosure. The sidewall 324 separate the channel 500 from the cavity 302. In an embodiment, the channel 500 may include a constant thickness around the cavity 302. The channel 500 may be similarly shaped as the base 106 and/or the cavity 302. For example, the channel 500 may include a central region 700, a first arm 702, and a second arm 704. The central region 700 may be disposed at least partially around the central region 700 of the cavity 302, the first arm 702 may be disposed around the first arm 306 of the cavity 302, and the second arm 704 may be disposed around the second arm 308 of the cavity 302. The channel 500 may be continuous between the central region 700, the first arm 702, and the second arm 704.

The first arm 702 may include a first length 706 (e.g., in the X-direction) and the second arm 704 may include a second length 708 (e.g., in the X-direction). In an embodiment, the first length 706 may be greater than the second length 708. A first width 710 may extend between opposing sides of the first arm 702 and a second width 712 may extend between opposing sides of the second arm 704. The first width 710 may be greater than the second width 712. The central region 700 may include a third length 714 (e.g., in the X-direction) that is less than the first length 706 and/or the second length 708. The central region 700 may include a third width 716 (e.g., in the Z-direction) that may be greater than the first width 710 and/or the second width 712.

Although the channel 500 is described as being similarly shaped as the base 106 and/or the cavity 302, the channel 500 may be shaped differently. For example, the sidewall 324 may not include a constant thickness around the cavity 302. However, in an embodiment, the channel 500 may be complimentary shaped to the cavity 302 to reduce an amount of sealant injected into the cavity 302 to seal the cavity 302 against the surface 104.

In an embodiment, the base 106 may be symmetrical about a first axis 718. The aperture 112, the first port 118, and the second port 120 may be disposed along the first axis 718. A second axis 720 may be disposed through the aperture 112, and may be perpendicular to the first axis 718. The base 106 may not be symmetrical about the second axis 720.

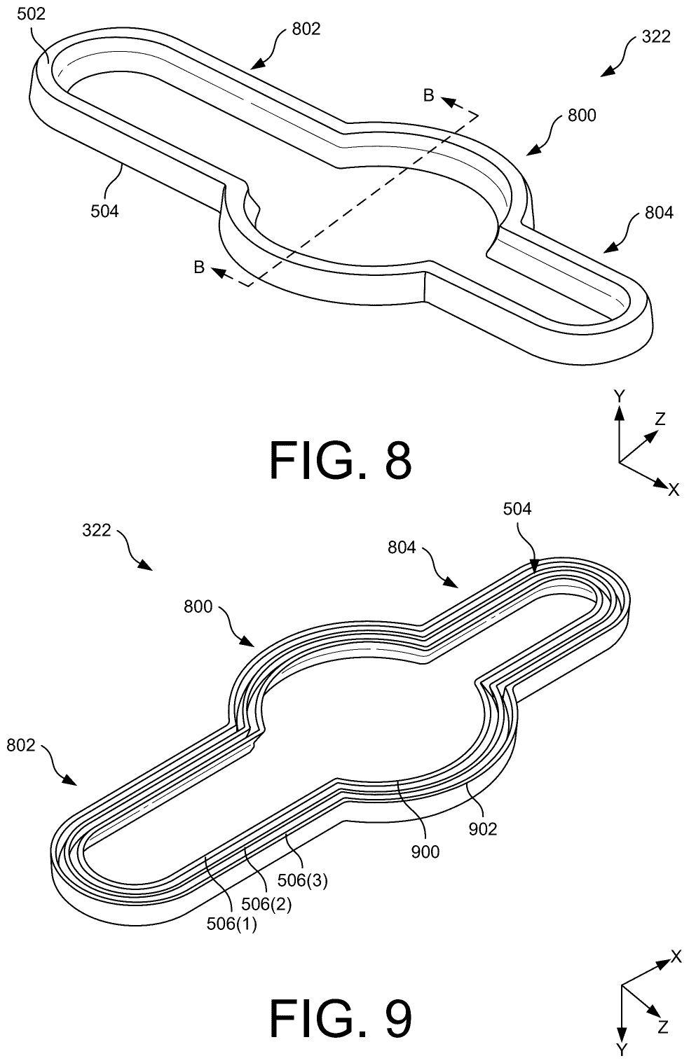

FIG. 8 illustrates a top isometric view of the seal 322, according to examples of the present disclosure. The seal 322 may be complimentary to the shape of the channel 500 to be at least partially disposed in the channel 500. For example, the seal 322 may include a central region 800, a first arm 802, and a second arm 804. The central region 800 may be disposed within the central region 700 of the channel 500, the first arm 802 may be disposed within the first arm 702 of the channel 500, and the second arm 804 may be disposed within the second arm 704 of the channel 500.

As introduced above, the seal 322 may include the top 502 that is disposed within the channel 500 and the bottom 504 disposed external to the channel 500 for engaging with the surface 104. In an embodiment, the seal 322 may be press-fit, compression-fit, adhered, etc., within the channel 500. For example, adhesive may be disposed along the top 502 and adhered against the bottom surface 600, at a location within the channel 500, for securing the seal 322 within the channel 500.

The seal 322 may be manufactured from EPDM. Alternative material, such as rubber, neoprene, etc., may be used. In an embodiment, the seal 322 may be reinforced with wires. In an embodiment, the seal 322 may be alternatively referred to as a gasket, washer, etc.

FIG. 9 illustrates a bottom isometric view of the seal 322, according to examples of the present disclosure. The bottom 504 of the seal 322 may include the one or more fingers 506, such as a first finger 506(1), a second finger 506(2), and a third finger 506(3). The first finger 506(1) may be disposed along an interior perimeter 900 of the seal 322 while the third finger 506(3) may be disposed around along an exterior perimeter 902 of the seal 322.

Although the seal 322 is described as having three of the fingers 506, the seal 322 may include more than or less than three of the fingers 506. In an embodiment, the fingers 506 may be sized similarly or different than one another, for example, in length (e.g., in the Y-direction) and/or width.

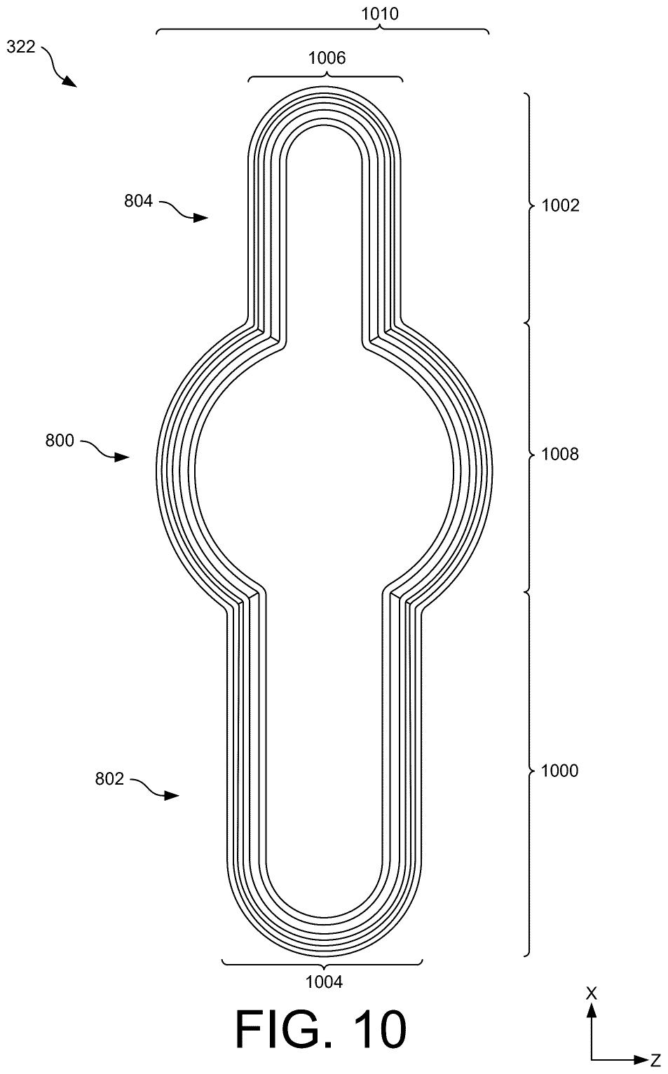

FIG. 10 illustrates a bottom planar view of the seal 322, according to examples of the present disclosure. The first arm 802 may include a first length 1000 (e.g., in the X-direction) and the second arm 804 may include a second length 1002 (e.g., in the X-direction). In an embodiment, the first length 1000 may be greater than the second length 1002. A first width 1004 (e.g., in the Z-direction) may extend between opposing sides, along the exterior perimeter 902, of the first arm 802 and a second width 1006 (e.g., in the Z-direction) may extend between opposing sides, along the exterior perimeter 902, of the second arm 804. The first width 1004 may be greater than the second width 1006.

The central region 800 may include a third length 1008 (e.g., in the X-direction) that is less than the first length 1000 and/or greater than the second length 1002. The central region 800 may include a third width 1010 (e.g., in the Z-direction) that extends between opposing sides, along the exterior perimeter 902. The third width 1010 may be greater than the first width 1004 and/or the second width 1006.

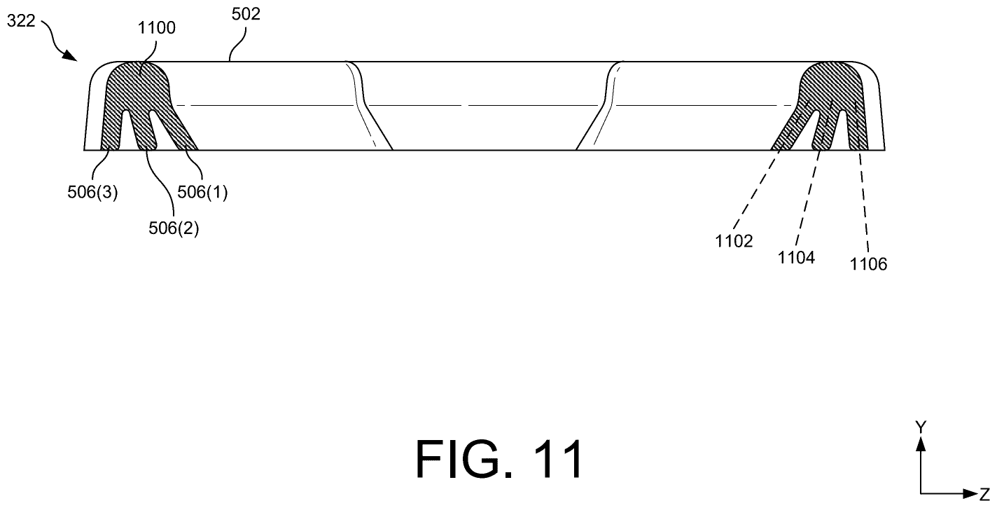

FIG. 11 illustrates a cross-sectional view of the seal 322, taken along line B—B of FIG. 8, according to examples of the present disclosure. As introduced above, the seal 322 includes the fingers 506, such as the first finger 506(1), the second finger 506(2), and the third finger 506(3). The fingers 506 may extend from a base 1100 of the seal 322, disposed along or extending from the top 502. The fingers 506 are configured to engage the surface 104 and may compress against the surface 104 when the nut 116 is used to secure the base 106 to the surface 104. For example, the fingers 506 may flare to seal against the surface 104. Sealing of the seal 322 against the surface 104 may seal the cavity 302, for example, to route the sealant from the first port 118 to the second port 120, and to prevent the sealant being disposed external to the cavity 302.

In an embodiment, the fingers 506 may be disposed at different orientations, directions, etc. For example, the first finger 506(1) may be disposed at a first orientation 1102, the second finger 506(2) may be disposed at a second orientation 1104 different than the first orientation 1102, and/or the third finger 506(3) may be disposed at a third orientation 1106 different than the second orientation 1104.

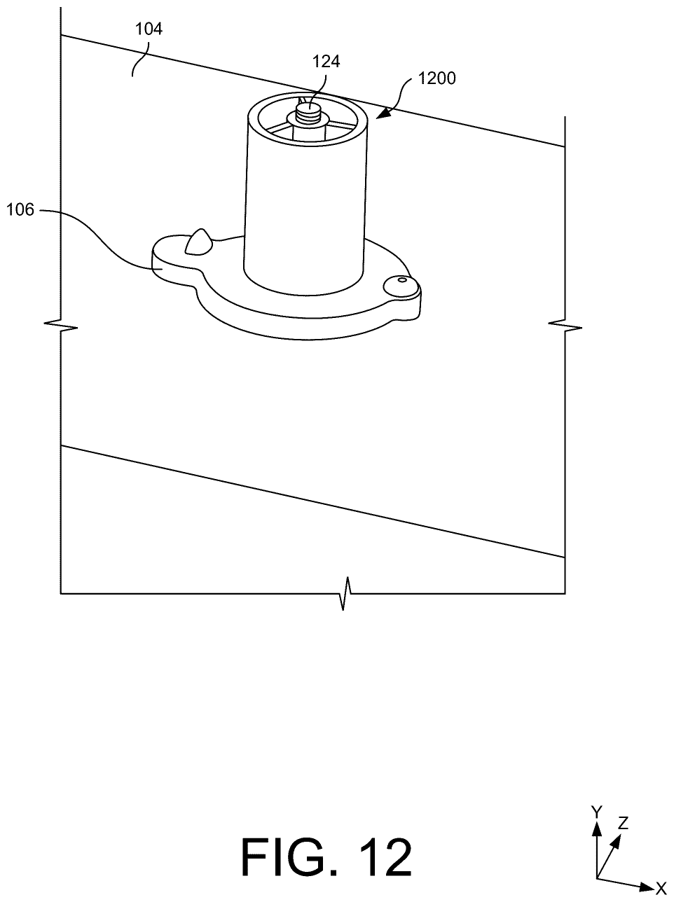

FIG. 12 illustrates a first attachment mechanism 1200 that may be secured to the surface 104, according to examples of the present disclosure. As shown, the base 106 may be disposed between the surface 104 and the first attachment mechanism 1200. The first attachment mechanism 1200 may include a passage through which the post 124 of the fastener 108 is disposed. The nut 116 may be threaded onto an end of the post 124. In an embodiment, a rail may be disposed adjacent to the first attachment mechanism 1200, and the nut 116 may be used to secure the rail to the surface 104. Therein, solar panel modules, for example, may be disposed along the rail.

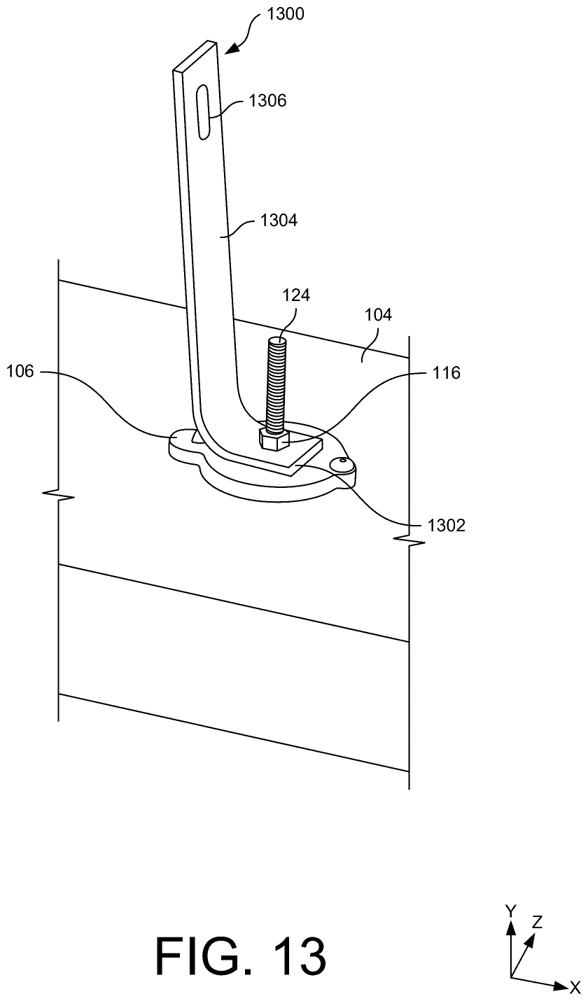

FIG. 13 illustrates a second attachment mechanism 1300 that may be secured to the surface 104, according to examples of the present disclosure. As shown, the base 106 may be disposed between the surface 104 and the second attachment mechanism 1300. The second attachment mechanism 1300 may include a passage through which the post 124 of the fastener 108 is disposed. The second attachment mechanism 1300 may include a first leg 1302 and a second leg 1304, whereby first leg 1302 may include a passage disposed over the post 124 (e.g., opening, hole, aperture, etc.). Therein, the nut 116 may be threaded onto an end of the post 124 to secure the second attachment mechanism 1300 to the surface 104.

The second attachment mechanism 1300 is also shown including a slot 1306 disposed through the second leg 1304. Fasteners may be disposed through the slot 1306 for attaching solar panel modules, rails, brackets, mounts, etc., to the second attachment mechanism 1300.

Although the first attachment mechanism 1200 and the second attachment mechanism 1300 are shown being secured to the surface 104 via the assembly 100, other attachment mechanism 102, brackets, mounts, etc., may attach to the surface 104 using the assembly 100.

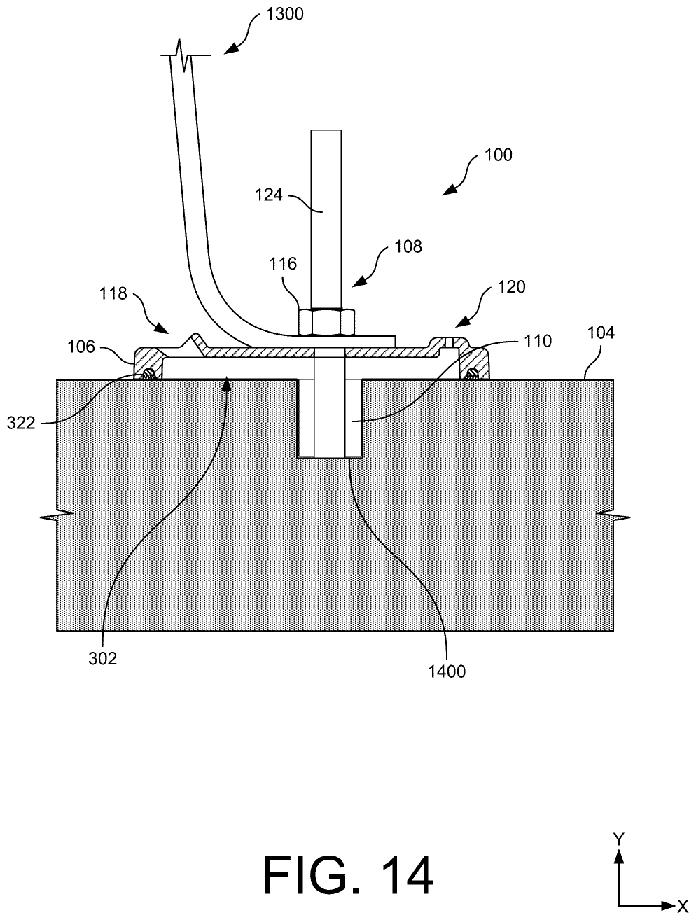

FIG. 14 illustrates a cross-sectional view of the assembly 100 and the second attachment mechanism 1300, according to examples of the present disclosure.

To install the assembly 100, initially, a hole 1400 is drilled into the surface 104 to accommodate the fastener 108. The fastener 108, such as the sleeve 122, may be at least partially disposed into the hole 1400 and the post 124 may extend above the surface 104. The aperture 112 in the base 106 may be disposed over the post 124, such that the seal 322 is disposed against the surface 104. The passage of the second attachment mechanism 1300 may be disposed over the post 124, such that the first leg 1302 is disposed adjacent to the top 206 of the base 106. The nut 116 may be threaded onto the post 124 and tightened. During tightening of the nut 116, the sleeve 122 may expand and secure the fastener 108 within the hole 1400. Additionally, the nut 116 may urge against the base 106 and consequently, the fingers 506 of the seal 322 against the surface 104.

Once the nut 116 is secured, the sealant may be injected into the cavity 302, via the first port 118. The seal 322 may enclose the cavity 302 to direct the sealant towards the second port 120. Additionally, as the sealant is injected into the cavity 302, the sealant may flow around the fastener 108 to seal the hole 1400. Moreover, as the sealant fills the cavity 302, air is purged out of the cavity 302 via the second port 120. The sealant may exit the cavity 302, via the second port 120, to provide a visual indication that the cavity 302 is filled with the sealant.

Although the discussion is with regard to injecting the sealant after the nut 116 is tightened, in an embodiment, the sealant may be injected before the nut 116 is fastened, before the nut 116 is fully fastened, etc. In an embodiment, the nut 116 may secure the assembly 100 to the surface 104, and a second nut, for example, threaded onto the post 124 may be used to secure the second attachment mechanism 1300 to the post 124. In an embodiment, the base 106 may include other features (e.g., flanges, brackets, etc.) for attaching the second attachment mechanism 1300.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An apparatus for securing solar panels to a surface, the apparatus comprising:
a base including:
a first port,
a second port,
an aperture disposed between the first port and the second port,
a cavity fluidly connected to the aperture, the first port, and the second port, the cavity to receive a sealant for sealing the base against the surface; and
a channel disposed around cavity; and
a seal disposed within the channel.

2. The apparatus of claim 1, wherein:
the base includes:
a top, and
a bottom;
the first port, the second port, and the aperture are disposed on the top; and
the channel is disposed on the bottom.

3. The apparatus of claim 2, wherein:
the first port is disposed at an acute angle relative to the top; and
at least one of the second port or the aperture is disposed perpendicular to the top.

4. The apparatus of claim 1, wherein the seal includes one or more fingers that seal against the surface.

5. The apparatus of claim 1, wherein:
the cavity includes:
a central region,
a first arm extending from the central region, and
a second arm extending from the central region, at a location diametrically opposed from the first arm;
the first port is disposed within the first arm of the cavity;
the second port is disposed within the second arm of the cavity; and
the aperture is disposed within the central region of the cavity.

6. The apparatus of claim 1, wherein:
the aperture is configured to receive a fastener disposed in the surface; and
a nut threads onto an end of the fastener to secure the apparatus to a surface.

7. An assembly comprising:
a base including:
a top,
a bottom,
a first port disposed on the top,
a second port disposed on the top,
an aperture disposed on the top, the aperture to receive a portion of a fastener disposed in a surface,
a cavity disposed on the bottom, the cavity to receive a sealant injected into the first port for sealing the assembly against the surface, and
a channel circumscribing the cavity; and
a seal disposed in the channel.

8. The assembly of claim 7, wherein:
the first port, the second port, and the aperture are disposed along an axis; and
the assembly is symmetrical about the axis.

9. The assembly of claim 7, wherein the seal includes one or more fingers that seal against the surface.

10. The assembly of claim 7, wherein the cavity includes:
a central region;
a first arm extending from the central region; and
a second arm extending from the central region.

11. The assembly of claim 10, wherein:
the first port is disposed within the first arm of the cavity;
the second port is disposed within the second arm of the cavity; and
the aperture is disposed within the central region of the cavity.

12. The assembly of claim 10, wherein:
the first arm includes a first length;
the second arm includes a second length that is less than the first length; and
the central region includes a third length that is less than the second length.

13. The assembly of claim 12, wherein:
the first arm includes a first width;
the second arm includes a second width less than the first width; and
the central region includes a third width greater than the first width.

14. The assembly of claim 7, wherein a nut is threaded onto the portion of the fastener for securing the assembly to the surface.

15. The assembly of claim 7, wherein:
the first port is oriented at an acute angle relative to the top; and
at least one of the second port or the aperture is disposed perpendicular to the top.

16. An apparatus comprising:
a base;
a cavity formed in the base, the cavity including:
a central region,
a first arm extending from the central region, and
a second arm extending from the central region;
a first port fluidly connected to the first arm of the cavity;
a second port fluidly connected to the second arm of the cavity;
an aperture fluidly connected to the central region of the cavity; and
a seal including:
a central region disposed adjacent to the central region of the cavity,
a first arm extending from the central region of the seal, the first arm of the seal being disposed adjacent to the first arm of the cavity, and
a second arm extending from the central region of the seal, the second arm of the seal being disposed adjacent to the second arm of the cavity.

17. The apparatus of claim 16, further comprising a channel formed in the base, the channel being disposed around the cavity, and wherein the seal is disposed in the channel.

18. The apparatus of claim 16, wherein:
the base includes:
a top, and
a bottom opposite the top;
the first port, the second port, and the aperture are disposed through the top; and
the cavity is formed in the bottom.

19. The apparatus of claim 18, wherein:
the first port is disposed at an acute angle relative to the top; and
at least one of the second port or the aperture is disposed perpendicular to the top.

20. The apparatus of claim 16, wherein the first port is conically shaped.
